(19) United States
(12) Patent Application Publication
(10) Pub. No.: US 2010/0167257 A1
(43) Pub. Date: Jul. 1, 2010

(54) METHODS AND SYSTEMS FOR CREATING EDUCATIONAL RESOURCES AND ALIGNING EDUCATIONAL RESOURCES WITH BENCHMARKS

(76) Inventors: Hugh Norwood, Sykesville, MD (US); Clyde Boyer, Ellicott City, MD (US)

Correspondence Address: CHOATE, HALL & STEWART LLP, TWO INTERNATIONAL PLACE, BOSTON, MA, 02110, US

(21) Appl. No.: 12/628,845

(22) Filed: Dec. 1, 2009

Related U.S. Application Data
(60) Provisional application No. 61/119,025, filed on Dec. 1, 2008.

(51) Int. Cl. G09B 5/00; G09B 3/00

(52) U.S. Cl. 434/308; 434/350

(57) ABSTRACT

A system for creating and managing educational resources, and aligning those educational resources with at least one educational benchmark, includes a resource builder executing on a computing machine. The resource builder includes at least two disparate educational devices in the educational resource. The two disparate educational devices include a first educational device that has a first media format, and a second educational device that has a second media format different from the first media format. The resource builder includes in the educational resource a version of an educational device that corresponds to a selected language preference. An educational alignment engine selects at least one educational benchmark that corresponds to a student, a student cohort or a class. The educational alignment engine assigns the educational resource to the selected educational benchmark, and configures a date range of the selected educational benchmark according to a curriculum map.

### RELATED APPLICATIONS

This U.S. patent application claims priority to U.S. Provisional Patent Application Ser. No. 61/119,025, filed on Dec. 1, 2008, the disclosure of which is considered part of the disclosure of this application and is herein incorporated by reference in its entirety.

### FIELD OF THE DISCLOSURE

This disclosure relates to managing educational resources. In particular, this disclosure relates to creating educational resources from disparate educational devices, and aligning educational resources with one or more educational benchmarks.

### BACKGROUND OF THE DISCLOSURE

Online educational tools have become a useful way for students, teachers and parents to communicate with one another. Teachers often use online educational tools as a way to communicate assignments to students and their parents, and as way to organize and manage a teacher's various classes and students. Likewise, students often use online educational tools as a way to organize and manage their various classes and assignments. In many instances, the educational resources available to students and teachers are those resources imported into a system by a teacher. Further, in many instances educational resources are available to teachers and students on a class-by-class basis.

In many school systems, student benchmarks are dictated by local, regional, state or the federal government. Student benchmarks are typically published in a static format, in a single language and are difficult to navigate. Furthermore, student benchmarks are typically sequential in nature and cover different periods during the instructional calendar therefore making it difficult to track student benchmarks. There exist very few systems that permit users search through student benchmarks, assign alternative date ranges to student benchmarks, or assign educational resources to student benchmarks. Many online educational tools permit students, teachers and parents to measure performance on a class-by-class basis. Few if any online educational tools allow students, teachers and parents to assign a student benchmark to a student, educational resource or student cohort.

Many educational tools fail to provide parents with an opportunity to be involved with a child's education. Parents, in many cases, have very little time, they don't know how to be involved, they are not available at scheduled times, there are language or cultural barriers, or they do not feel welcomed at school. Few if any online educational tools address these common issues by involving the parents and providing the parents with a way to be more involved with their child's education.

### SUMMARY OF THE INVENTION

Described herein are systems and methods for creating educational resources, managing educational resources and aligning those educational resources with student or educational benchmarks. Many online educational tools fail to allow users to combine multiple versions of educational resources in multiple languages and they fail to permit users to search multiple resources for educational devices and/or educational resources. Additionally, many online educational tools permits students and teachers to assign educational resources on a class-by-class basis. The methods and systems described herein allow for the creation of educational resources that include multiple versions of an educational device, where each version is in a different language. Additionally, the described methods and systems allow users to include multiple educational devices in the educational resource, and allow teachers to assign an educational resource to student groups rather than to a single student or class of students. The methods and systems described herein also permit teachers to associate educational resources to other educational resources, teachers, classes, to a group of students or to a single student, or any other related information or individuals.

In one aspect, described herein is a method for creating an educational resource from one or more disparate educational devices. In one embodiment, a resource builder executing on a computing machine includes at least two disparate educational devices in an educational resource comprising metadata. The at least two disparate educational devices include a first educational device having a first media format and a second educational device having a second media format different from the first media format. In some embodiments, the resource builder updates the educational resource metadata to include a language preference. The resource builder, in some embodiments, includes a version of an educational device corresponding to the language preference.

In one embodiment, updating the educational resource metadata includes selecting a first language from a plurality of languages, and inserting the selected language into an educational resource configuration interface. In another embodiment, including a version of the educational device includes identifying a version of the educational device written in a language corresponding to the language preference, and including the identified version of the educational device in the educational resource.

In still another embodiment, the first educational device has a first media format that can include any of the following media formats: audio, text, video, presentation, spreadsheet or multimedia. In yet another embodiment, the second educational device has a second media format that can include any of the following media formats: audio, text, video, presentation, spreadsheet or multimedia.

In one embodiment, the method can further include assigning the educational resource to a first student cohort. In some embodiments, a class builder executing on the computing machine, selects one or more students from a group of available students, and assigns the selected one or more students to the first student cohort. In another embodiment, the class builder executing on the computing machine may create a class or group shell, respectively, using information corresponding to or identifying a class or group. In a further embodiment, an educator may populate or associate the class or group shell with one or more educational resources. In another further embodiment, the class or group shell may comprise a unique code. In a still further embodiment, a student or students may join or self-assign themselves to the class or group shell via the unique code.

The resource builder, in some embodiments, searches for educational devices in one or more educational device storage repositories on the computing machine.

In other embodiments, an alignment engine executing on the computing machine, aligns the educational resource with a benchmark selected from a plurality of benchmarks.

In some embodiments, the resource builder edits the educational resource metadata to include a media format description and an educational resource description.

In yet another aspect, described herein is a method for aligning an educational resource comprising one or more disparate educational devices, with at least one educational benchmark. An educational alignment engine executing on a computing machine, selects at least one educational benchmark that corresponds to a student, a student cohort or a class. The educational alignment engine selects an educational resource that includes one or more disparate educational devices, where the at least two disparate education devices include a first educational device that has a first media format and a second educational device that has a second media format that is different from the first media format. The educational alignment engine then assigns the selected educational resource to the selected educational benchmark, and configures a date range for the selected educational benchmark according to a curriculum map. In a further embodiment, the educational alignment engine may create versions of the selected educational benchmark in one or more additional languages. In a still further embodiment, the versions of a benchmark in the one or more additional languages may be associated with each other and the first language, and, in some embodiments, may be joined into a single multi-language benchmark.

In some embodiments, the educational alignment engine searches within a database storing a plurality of educational benchmarks, for an educational benchmark that corresponds to a resource that is associated with a student, a student cohort or a class. Searching for the educational benchmark can, in some embodiments, include selecting a language preference, and searching for the educational benchmark in the selected language preference.

In some embodiments, selecting at least one educational benchmark can include selecting at least one educational benchmark that includes a district educational standard, a state educational standard and/or a national educational standard.

In yet another aspect, described herein is a system for creating and managing an educational resource that includes one or more disparate educational devices. The system can include a computing machine, and a resource builder that executes on the computing machine. The resource builder can include in an educational resource at least two disparate educational devices. The two disparate educational devices can include a first educational device that has a first media format and a second educational device that has a second media format that is different from the first media format. The resource builder can update the educational resource metadata to include a language preference, and can include in the educational resource, a version of an educational device that corresponds to the language preference. An educational alignment engine that executes on the computing machine, can select at least one educational benchmark that corresponds to a student, a student cohort or a class. The educational alignment engine can assign the educational resource to the selected educational benchmark, and can configure a date range of the selected educational benchmark according to a curriculum map.

In some embodiments, the resource builder can assign the educational resource to a first student cohort. The system can, in some embodiments, further include a class builder that executes on the computing machine to select one or more students from a group of available students. In some embodiments, the class builder can assign the selected one or more students to the first student cohort. In other embodiments, the students may join the class or cohort via a unique code, as discussed above with regard to the class builder.

In still other embodiments, the resource builder can identify a version of the educational device that corresponds to the language preference. The resource builder can then include the identified version of the educational device in the educational resource.

### BRIEF DESCRIPTION OF THE DRAWINGS

The following figures depict certain illustrative embodiments of the methods and systems described herein, where like reference numerals refer to like elements. Each depicted embodiment is illustrative of the method and system and not limiting.

FIG. 1A is a block diagram illustrative of an embodiment of a remote-access, networked environment with a client machine that communicates with a server.

FIGS. 1B and 1C are block diagrams illustrative of an embodiment of computing machines for practicing the methods and systems described herein.

FIGS. 2A and 2B are block diagrams of relationships between educational devices, resources and benchmarks.

FIG. 2C is a block diagram of an embodiment of a system for aligning and assigning educational devices and resources, and groups and students.

FIG. 3 is a flow diagram of a method for including one or more disparate educational devices in an educational resource.

FIG. 4 is a flow diagram of a method for creating a group or class.

FIG. 5 is a flow diagram of a method for aligning an educational resource with an educational benchmark.

FIG. 6 is a screen shot for a parent user interface.

### DETAILED DESCRIPTION

### A. Network and Computing Environment

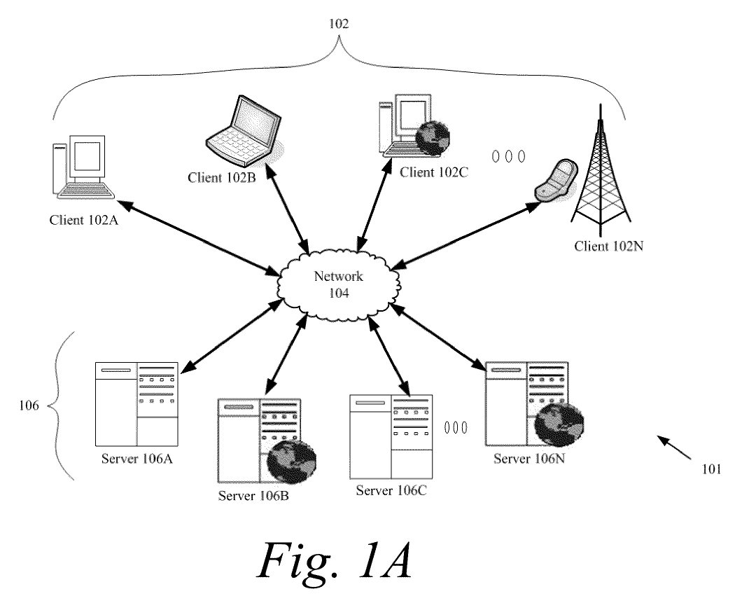

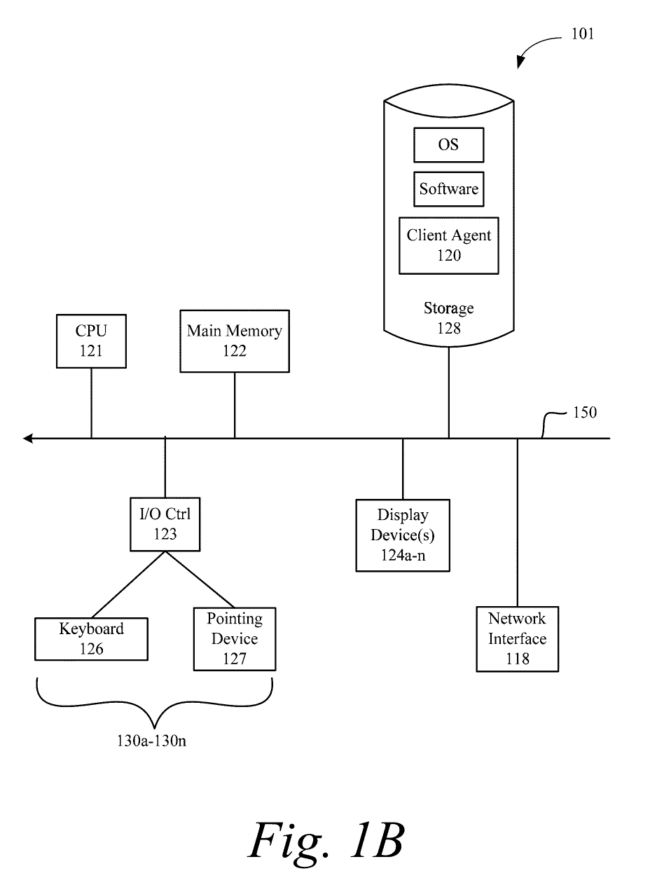

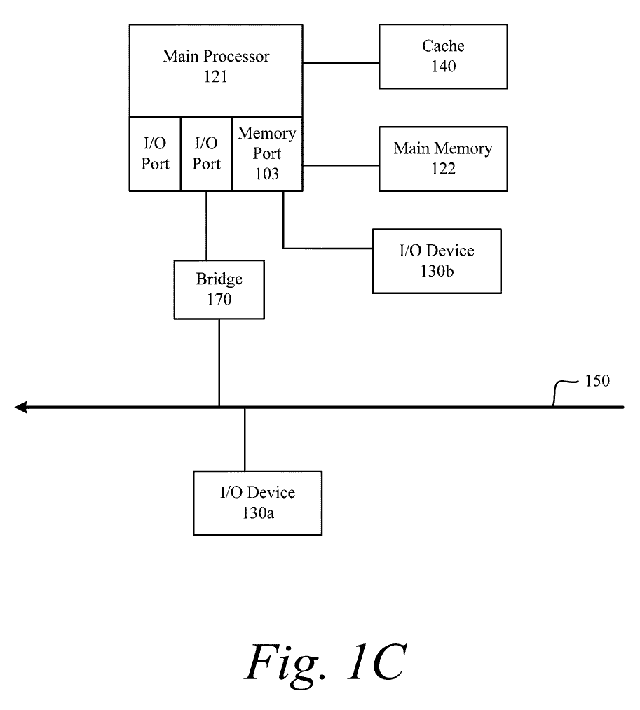

Prior to discussing the specifics of embodiments of the systems and methods of an appliance and/or client, it may be helpful to discuss the network and computing environments in which such embodiments may be deployed. Referring now to FIG. 1A, illustrated is one embodiment of a computing environment 101 that includes one or more client machines 102A-102N in communication with servers 106A-106N, and a network 104 installed in between the client machines 102A-102N and the servers 106A-106N. In some embodiments, client machines 102A-10N may be referred to as a single client machine 102 or a single group of client machines 102, while servers may be referred to as a single server 106 or a single group of servers 106. One embodiment includes a single client machine 102 communicating with more than one server 106, another embodiment includes a single server 106 communicating with more than one client machine 102, while another embodiment includes a single client machine 102 communicating with a single server 106.

A client machine 102 within the computing environment may in some embodiments, be referenced by any one of the following terms: client machine(s) 102; client(s); client computer(s); client device(s); client computing device(s); client node(s); endpoint(s); endpoint node(s); or a second machine. The server 106, in some embodiments, may be referenced by any one of the following terms: server(s), server farm(s), host computing device(s), or a first machine(s).

The client machine 102 can in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 102. Still other embodiments may include a computing environment 101 with an application that is any of either server-based or remote-based, and an application that is executed on the server 106 on behalf of the client machine 102. Further embodiments of the computing environment 101 include a server 106 configured to display output graphical data to a client machine 102 using a thin-client or remote-display protocol, where the protocol used can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

In one embodiment, the client machine 102 can be a virtual machine 102C managed by a hypervisor such as those manufactured by XenSolutions, Citrix Systems, IBM, VMware. In other embodiments, the client machine 102 can be any virtual machine able to implement the methods and systems described herein.

The computing environment 101 can, in some embodiments, include more than one server 106A-106N where the servers 106A-106N are: grouped together as a single server 106 entity, logically-grouped together in a server farm 106; geographically dispersed and logically grouped together in a server farm 106, located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity or in other embodiments may include multiple server farms 106. The computing environment 101 can include more than one server 106A-106N grouped together in a single server farm 106 where the server farm 106 is heterogeneous such that one server 106A-106N is configured to operate according to a first type of operating system platform (e.g., WINDOWS NT, manufactured by Microsoft Corp. of Redmond, Wash.), while one or more other servers 106A-106N are configured to operate according to a second type of operating system platform (e.g., Unix or Linux); more than one server 106A-106N is configured to operate according to a first type of operating system platform (e.g., WINDOWS NT), while another server 106A-106N is configured to operate according to a second type of operating system platform (e.g., Unix or Linux); or more than one server 106A-106N is configured to operate according to a first type of operating system platform (e.g., WINDOWS NT) while more than one of the other servers 106A-106N are configured to operate according to a second type of operating system platform (e.g., Unix or Linux).

The computing environment 101 can in some embodiments include a server 106 or more than one server 106 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 configured to operate as application acceleration application that provides firewall functionality, application functionality, or load balancing functionality, or other type of computing machine configured to operate as a server 106. In some embodiments, a server 106 may include a remote authentication dial-in user service such that the server 106 is a RADIUS server. Embodiments of the computing environment 101 where the server 106 comprises an appliance, the server 106 can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a server 106 with the following functionality: a first server 106A that receives requests from a client machine 102, forwards the request to a second server 106B, and responds to the request generated by the client machine with a response from the second server 106B; acquires an enumeration of applications available to the client machines 102 and address information associated with a server 106 hosting an application identified by the enumeration of applications; presents responses to client requests using a web interface; communicates directly with the client 102 to provide the client 102 with access to an identified application; receives output data, such as display data, generated by an execution of an identified application on the server 106.

The server 106 can be configured to execute any one of the following applications: an application providing a thin-client computing or a remote display presentation application; any portion of the CITRIX ACCESS SUITE by Citrix Systems, Inc. like the METAFRAME or CITRIX PRESENTATION SERVER; MICROSOFT WINDOWS Terminal Services manufactured by the Microsoft Corporation; or an ICA client, developed by Citrix Systems, Inc. Another embodiment includes a server 106 configured to execute an application so that the server may function as an application server such as any one of the following application server types: an email server that provides email services such as MICROSOFT EXCHANGE manufactured by the Microsoft Corporation; a web or Internet server; a desktop sharing server; or a collaboration server. Still other embodiments include a server 106 that executes an application that is any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

In one embodiment, the server 106 may be a virtual machine 106B such as those manufactured by XenSolutions, Citrix Systems, IBM, VMware, or any other virtual machine able to implement the methods and systems described herein.

Client machines 102 may function, in some embodiments, as a client node seeking access to resources provided by a server 106, or as a server 106 providing other clients 102A-102N with access to hosted resources. One embodiment of the computing environment 101 includes a server 106 that provides the functionality of a master node. Communication between the client machine 102 and either a server 106 or servers 106A-106N can be established via any of the following methods: direct communication between a client machine 102 and a server 106A-106N in a server farm 106; a client machine 102 that uses a program neighborhood application to communicate with a server 106A-106N in a server farm 106; or a client machine 102 that uses a network 104 to communicate with a server 106A-106N in a server farm 106. One embodiment of the computing environment 101 includes a client machine 102 that uses a network 104 to request that applications hosted by a server 106A-106N in a server farm 106 execute, and uses the network 104 to receive from the server 106A-106N graphical display output representative of the application execution. In other embodiments, a master node provides the functionality required to identify and provide address information associated with a server 106 hosting a requested application. Still other embodiments include a master node that can be any one of the following: a server 106A-106N within the server farm 106; a remote computing machine connected to the server farm 106 but not included within the server farm 106; a remote computing machine connected to a client 102 but not included within a group of client machines 102; or a client machine 102.

The network 104 between the client machine 102 and the server 106 is a connection over which data is transferred between the client machine 102 and the server 106. Although the illustration in FIG. 1A depicts a network 104 connecting the client machines 102 to the servers 106, other embodiments include a computing environment 101 with client machines 102 installed on the same network as the servers 106. Other embodiments can include a computing environment 101 with a network 104 that can be any of the following: a local-area network (LAN); a metropolitan area network (MAN); a wide area network (WAN); a primary network 104 comprised of multiple sub-networks 104′ located between the client machines 102 and the servers 106; a primary public network 104 with a private sub-network 104′; a primary private network 104 with a public sub-network 104′; or a primary private network 104 with a private sub-network 104′. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 104 that includes a wireless link where the wireless link can be an infrared channel or satellite band; or any other network type able to transfer data from client machines 102 to servers 106 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 102 to servers 106, and vice versa, to accomplish the methods and systems described herein. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; and a network interface 118. In one embodiment, the storage memory 128 includes: an operating system, software routines, and a client agent 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits capable of executing the systems and methods described herein. Still other embodiments of the central processing unit 122 may include any combination of the following: a microprocessor, a microcontroller, a central processing unit with a single processing core, a central processing unit with two processing cores, or a central processing unit with more than one processing cores.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O devices 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121 via an Advanced Graphics Port (AGP). Still other versions of the computing machine 100 include a processor 121 connected to an I/O device 130A-130N via any one of the following connections: HyperTransport, Rapid I/O, or InfiniBand. Further embodiments of the computing machine 100 include a communication connection where the processor 121 communicates with one I/O device 130A using a local interconnect bus and with a second I/O device 130B using a direct connection.

Included within some embodiments of the computing device 100 is each of a main memory unit 122 and cache memory 140. The cache memory 140 will in some embodiments be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device capable of executing the systems and methods described herein. The main memory unit 122 and/or the cache memory 140 can in some embodiments include one or more memory devices capable of storing data and allowing any storage location to be directly accessed by the central processing unit 121. Further embodiments include a central processing unit 121 that can access the main memory 122 via one of either: a system bus 150; a memory port 103; or any other connection, bus or port that allows the processor 121 to access memory 122.

Although not illustrated for clarity, software embodying the methods and systems discussed below may be installed on the computing device 100 via any installation device. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS). Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to mulitple I/O devices 103A-130N to control the one or more I/O devices. Some embodiments of the I/O devices 130A-130N may be configured to provide storage or an installation medium, while others may provide a universal serial bus (USB) interface for receiving USB storage devices such as the USB Flash Drive line of devices manufactured by Twintech Industry, Inc. Still other embodiments of an I/O device 130 may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can connect to multiple display devices 124A-124N, in other embodiments the computing device 100 can connect to a single display device 124, while in still other embodiments the computing device 100 connects to display devices 124A-124N that are the same type or form of display, or to display devices that are different types or forms. Embodiments of the display devices 124A-124N can be supported and enabled by the following: one or multiple I/O devices 130A-130N; the I/O controller 123; a combination of I/O device(s) 130A-130N and the I/O controller 123; any combination of hardware and software able to support a display device 124A-124N; any type and/or form of video adapter, video card, driver, and/or library to interface, communicate, connect or otherwise use the display devices 124A-124N. The computing device 100 may in some embodiments be configured to use one or multiple display devices 124A-124N, these configurations include: having multiple connectors to interface to multiple display devices 124A-124N; having multiple video adapters, with each video adapter connected to one or more of the display devices 124A-124N; having an operating system configured to support multiple displays 124A-124N; using circuits and software included within the computing device 100 to connect to and use multiple display devices 124A-124N; and executing software on the main computing device 100 and multiple secondary computing devices to enable the main computing device 100 to use a secondary computing device's display as a display device 124A-124N for the main computing device 100. Still other embodiments of the computing device 100 may include multiple display devices 124A-124N provided by multiple secondary computing devices and connected to the main computing device 100 via a network.

In some embodiments of the computing machine 100, an operating system may be included to control task scheduling and access to system resources. Embodiments of the computing device 100 can run any one of the following operation systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; and WINDOWS 7; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system capable of running on the computing device and performing the operations described herein. One embodiment of the computing machine 100 has multiple operating systems installed thereon.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA), such as the i55sr, i58sr, i85s, i88s, i90c, i95c1, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. Still other embodiments of the computing environment 101 include a mobile computing device 100 that can be any one of the following: any one series of Blackberry, or other handheld device manufactured by Research In Motion Limited; the iPhone manufactured by Apple Computer; any handheld or smart phone; a Pocket PC; a Pocket PC Phone; or any other handheld mobile device supporting Microsoft Windows Mobile Software.

### B. Aligning and Assigning Resources and Benchmarks

An educational device or devices, referred to variously and interchangeably as a device, a lesson, educational content, an instruction, or any other equivalent term, can be educational content or groups of content useable by educators, teachers, and students as part of a curriculum or curriculums. These devices may be in one or more languages, and in some embodiments, a device in a first language may be linked or associated with a translation of the device in one or more additional languages. In some embodiments, these devices may include static content, such as text or images. In other embodiments, these devices may include dynamic content, such as video or audio, or animations. In still other embodiments, these devices may include interactive content, such as games, puzzles, quizzes, interactive demonstrations, dynamic models, or any other type and form of interactive lesson. In yet other embodiments, these devices may include any combination of static, dynamic, and interactive content, and may be associated with or linked to other devices or content.

In some embodiments, one or more devices may be grouped into an educational resource. A resource may include one or more related devices selected by an educator or administrator, and may further include metadata. In some embodiments, the one or more devices can be disparate such that at least two educational devices are different media formats. In this embodiment, a first educational device can be a first media format, while a second media device can be a second media format that is different from the first media format. A media format, in some embodiments, can be any file type, data type, data structure or other data format. In some embodiments, the media format can be any of the following: audio; text; graphic; video; presentation; spreadsheet; or multimedia. An audio format, in some embodiments, can be any of the following file formats: way; ogg; raw; au; midi; gsm; dct; mp4/m4a; mmf; vox; mp3; wma; ra; dss; msv; dvf; or any other audio file format. In other embodiments, a text file format can be any of the following file formats: pdf; doc; txt; html; tif; or any other text file format. A graphic format, in some embodiments, can be any of the following file formats: jpeg; gif; bmp; or any other graphic file format. Other file formats can include any of the following: mpeg; aiff; way; tiff; mov; mpeg-2; mp4; ogg; avi; realmedia; ppt; xls; or any other file format.

The educational resource, in some embodiments, can include a compressed or encoded educational device. In other embodiments, the educational resource can include an encrypted educational device. In embodiments where the educational resource includes one or more encoded, encrypted or compressed educational devices, the educational resource can also include any of the following: compression codecs; decompression codecs; and encryption keys.

In some embodiments, the educational resource can include metadata. The metadata, in some embodiments, may include a name, one or more authors, and a description. In another embodiment, the metadata may further include a resource type and a unique identifier. In still another embodiment, the metadata may include one or more tags or keywords, to aid in searching by a user or administrator, or for associating the resource with other resources. In yet another embodiment, the metadata may include an educational category or subject, such as “Algebra” or “History”. In yet another embodiment, the metadata may include a grade level or grade range. In still another embodiment, the metadata may include an identifier of a language of the resource, such as “English” or “Spanish”. To avoid confusion, it should be recognized that a language may be both an educational category or subject and a language of the resource. For example, an English class for Spanish-speakers may have a resource with a subject of “English” and a language of “Spanish”. It likely will also include resources with a subject of “English” and a language of “English”. In some embodiments, resources in different languages may be associated with each other or linked into a single multi-lingual resource. In another embodiment, the metadata may further include a directory or subdirectory that includes the resource, such as a directory of resources related to a particular subject, a particular grade, an age, a school district, or any other type and form of logical grouping of resources.

A benchmark, in some embodiments, may be a local, regional, state or national standard, a curriculum map, a district curricular benchmark, or any other type and form of measurable student expectation. For example, in one embodiment, a student benchmark may be a curriculum goal, such as being able to transform decimals to fractions, read Ovid in Latin, or name different bones in the human body. In one embodiment, a benchmark may be described in a file, such as an XML file or a database. In a further embodiment, the benchmark may include fields describing the benchmark, such as a title, a description, a subject matter, a grade level or levels, one or more keywords, or any other information. In other embodiments, the benchmark may include metadata or be associated with metadata, as described above in connection with resources. In these embodiments, the metadata of a benchmark may include a unique identifier, a directory, a subject, a grade level or range, a language, or any other information useful to educators or students. In some embodiments, a benchmark may be in multiple languages, or equivalent benchmarks in different languages may be associated with each other. Additionally, in some embodiments, a benchmark may be associated with a date or a date range. For example, a semester-long curriculum may include benchmarks for the first two weeks of class, benchmarks for the first month, benchmarks for the second month, benchmarks for mid-semester, etc. In some embodiments, the metadata of the benchmark may include information about the date or date range associated with the benchmark.

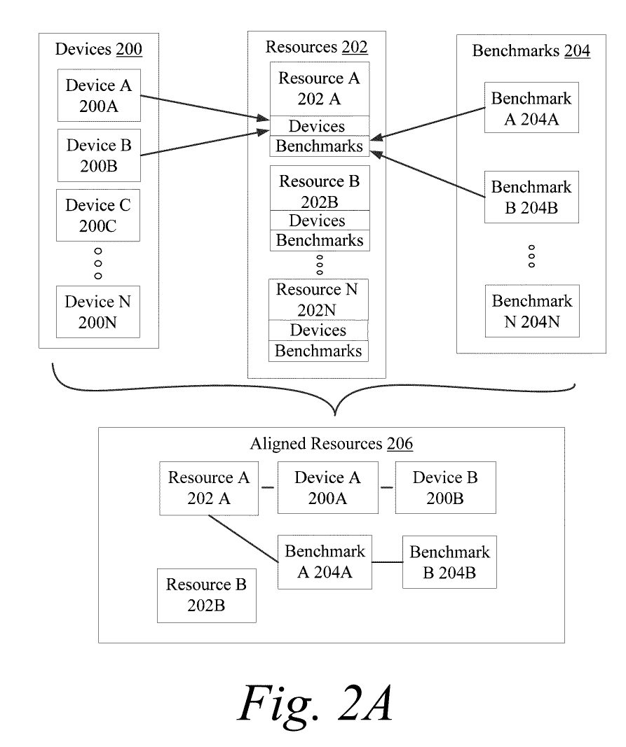

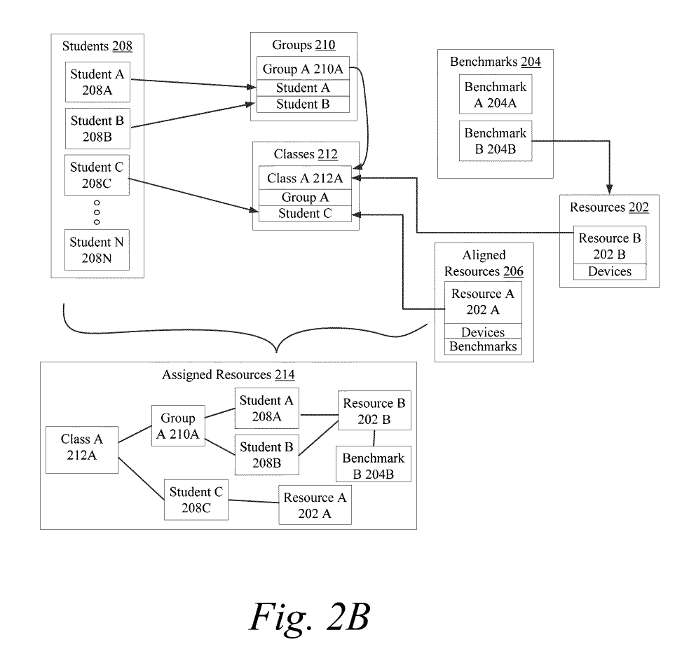

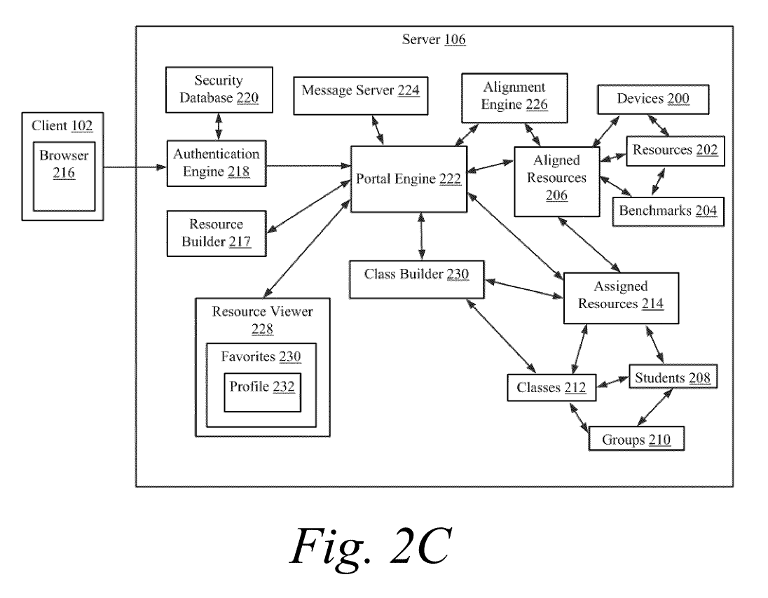

Referring now to FIG. 2A, illustrated is a block diagram of an embodiment of a relational database for managing content in an educational system. Briefly, in one embodiment, devices 200A-200N (referred to generally as educational devices 200) may be associated with one or more resources 202A-202N (referred to generally as educational resources 202) and/or benchmarks 204A-204N (referred to generally as educational or student benchmarks 204). In a further embodiment, one or more benchmarks 204 may be associated with one or more resources 202. In some embodiments, the sum of these interrelated associations are aligned resources 206. In other embodiments, alignment of resources may include creating a relational database or collection of tables. Such a database may be encoded in a computer database language, such as Structured Query Language (SQL), Object Query Language (OQL), Datalog, or any other applicable database language for managing a relational database. In one embodiment, devices and/or resources may be grouped based on their contents and/or the contents of their metadata. For example, devices and/or resources may be grouped in the relational database based on a class subject, grade level, and language. In some embodiments, benchmarks may be aligned in the same or a different relational database. Additionally, in some embodiments, resources may be aligned with benchmarks. For example, the metadata of a particular benchmark identifying it as a grade-6 history class may be used as a query to group and identify resources with matching metadata in the relational database.

Still referring to FIG. 2A and in more detail, in one embodiment, one or more educational devices 200 may be grouped or associated to form a resource 202. For example, in one embodiment, one or more devices for a specific class subject and grade level, such as videos, quizzes, and text relating to a history lesson, may be associated into a single resource for that lesson. In another embodiment, one or more benchmarks 204 may be associated with a resource 202. In another embodiment, one or more devices 200 may be associated with the same or a different resource 202 or benchmark 204. For example, in one such embodiment, a benchmark identifying a curriculum goal of learning cursive handwriting may be associated with one or more educational resources, which themselves are associated with one or more devices, such as videos and quizzes. Aligned resources 206 may be used in lesson planning by educators for finding devices and resources based on curriculum plans.

In some embodiments, an administrator or educator may build resources by associating them with one or more devices by using a resource builder or an alignment engine executing on the server 106, discussed in more detail below. In some embodiments, building resources may include the administrator or educator retrieving one or more devices from a local system or directory or first remote system or directory, and uploading the one or more resources to a second remote system or directory. In further embodiments, building resources may include the administrator or educator adding, configuring, or modifying metadata of the one or more resources, as discussed above. In some embodiments, items of the metadata may be added automatically by either the local system or remote system, such as a resource's unique ID or directory. For example, in one embodiment, an administrator may upload a demonstration video and create metadata associated with the video indicating it is an English-language video for a specified class, with a specified title and description. The system may then add one or more items of metadata, such as a unique ID, a subject relating to the specified class, a grade level associated with the specified class, a directory associated with the grade level and/or class, or any other available information.

In some embodiments, an administrator may upload benchmarks. In other embodiments, uploading benchmarks may include creating benchmarks for upload. As discussed above, a benchmark may be a file, array or database comprising information about a measureable student expectation, and may be encoded as text, XML, a database, or any other type and form of data. In some embodiments, a portal engine, resource builder or alignment engine, discussed below, may convert an uploaded benchmark file into a form useable by a relational database management system. In one such embodiment, an engine executing on a server may convert an XML file into fields and entities of a relational database and add said entities into corresponding fields of the database. For example, a benchmark file containing tags and entities indicating that the benchmark is for a specific grade level may be added to a relational database as a tuple corresponding to the benchmark with an indicator of the specific grade level in an attribute field for a grade level.

Although shown in FIG. 2A in the abstract as a series of relationships, aligned resources 206 may be included in one or more tables of a relational database. The aligned resources 206 may correspond to resources, devices, and benchmarks and attributes identified in metadata. In some embodiments, the aligned resources 206 may include metadata or any other information about a resource, device, or benchmark that may be useful to an educator or student. In the example embodiment shown in FIG. 2A, benchmarks A and B may be associated with resource A. Resource A 202A can include or be associated with Device A 200A and Device B 200B. Through the associations of the relational database, an educator seeking information on benchmark A 204A may be directed to educational Device A 200A and Device B 200B. Accordingly, the relational database can add efficiency for the educator in creating and assigning lessons.

Referring now to FIG. 2B, illustrated is a block diagram of an embodiment of a relational database for aligning resources with students and classes in an educational system. Briefly, in one embodiment, records of students 208A-208N (referred to generally as students 208) may be associated with one or more groups and/or classes 212. Student records 208, referred to interchangeably as students, may include one or more identifying data of a student, such as a student ID or unique identifier, first name, last name, age, grade, class, teacher name, GPA, class schedule, photo, parent names, address, or any other type and form of student information.

In a further embodiment, one or more students 208, groups 210, and/or classes 212 may be associated with one or more benchmarks 204, resources 202, and/or aligned resources 206. The sum of these interrelated associations can, in some embodiments, be assigned resources 214. In some embodiments, assignment of resources may include creating a relational database or collection of tables. Such a database may be encoded in a computer database language, such as Structured Query Language (SQL), Object Query Language (OQL), Datalog, or any other applicable database language for managing a relational database. In one embodiment, students, groups, classes, benchmarks, and/or aligned resources may be grouped based on their contents and/or the contents of their metadata. For example, students may be grouped in the relational database based on a class subject, grade level, and language. In another example, a benchmark identifying a curriculum goal for a certain grade and class may be grouped in the relational database with students also associated with the grade and class. In some embodiments, students, groups, classes, benchmarks, and resources may be aligned in the same or a different relational database from the aligned resources database.

Still referring to FIG. 2B and in more detail, in one embodiment, one or more students 208 may be grouped or associated to form a group 210 or student cohort 210. Additionally, one or more students and/or one or more groups may be grouped or associated to form a class 212. For example, in one embodiment, one or more students in a particular teacher's class may be grouped into a class 212. In another embodiment, students from one class may be grouped with students from another class, such as for a joint educational project between two classes. In another embodiment, one or more resources 202, benchmarks 204, and/or aligned resources 206 may be associated with a class 212, group 210, and/or individual student 208. For example, an educator may identify one or more benchmarks for a particular class, such as identifying the causes of the Civil War for a History class. The benchmark may be associated with one or more resources and/or devices, including videos, texts, lessons, games, quizzes, maps, and interactive material. Similarly, the class may be associated with one or more students. By associating the benchmark with the class, the resources and/or devices may be associated through the relational database with the students in the class. Accordingly, a student in the class seeking to view assignments and educational devices may be able to view all devices associated with the resources and/or benchmark by querying the database for devices associated with their unique identifier. Thus, rather than manually assigning a large number of devices to all students individually, an educator may identify a few group, class, and benchmark associations. The assignments may then be made automatically based on the relational database. Alternately, in some embodiments, one or more benchmarks may be associated with a resource. In such an embodiment, the educator may assign the resource to a student, group, or class, such that the benchmark is associated with the student via the associated assigned resource.

Similar to aligned resources 206 described in relation to FIG. 2A and shown in the abstract as a series of relationships, assigned resources 214 may include one or more relational databases comprising tables of tuples corresponding to students, groups, classes, resources, devices, and benchmarks and attributes corresponding to any of the metadata discussed above. In some embodiments, assigned resources may include a separate table in the same relational database as aligned resources 206, and/or may be created as a query of the relational database. In the example shown, benchmarks, resources, and devices may be associated directly with a student, such as resource A with student C, or may be associated with students through their association with a class, such as benchmark B with resource B, and resource B with students A-C through class A. Thus, by grouping students into groups and classes, and devices into resources and associated benchmarks through the relational database as discussed with regard to FIGS. 2A and 2B, an educator can quickly and easily find and assign curriculum-related educational devices to one or more students, merely by changing one or more associations in the database. This may be preferable to manually assigning dozens or hundreds of devices to dozens or hundreds of students.

Referring to FIG. 2C, a block diagram of an embodiment of a system for aligning and assigning resources is shown. Briefly, a client 102 may include a browser 216. The browser 216 may be used to communicate with a server 106. In some embodiments, the browser 216 may communicate with a portal engine 222 executing on the server, via an authentication engine 218 connected to a security database 220. In some embodiments, the portal engine 222 may provide functionality for communicating with a message server 224, an alignment engine 226, a resource viewer 228, and/or a class builder 230. In still other embodiments, the portal engine 222 may communicate with a resource builder 217.

Still referring to FIG. 2C and in more detail, in some embodiments, the client 102 may include a browser 216. In some embodiments, the browser 216 may include an application, function, routine, service, or process for accessing server 106. In one embodiment, the browser 216 may be a web browser, such as the Internet Explorer® web browser manufactured by Microsoft Corp. of Redmond, Wash.; the Safari® web browser manufactured by Apple, Inc.; the Chrome® web browser manufactured by Google, Inc.; or any other type and form of web browser. In some embodiments, functionality may be provided via one or more interactive web pages, scripts, JAVA® applets, Flash® interfaces, or other interactive data structures served from server 106 and accessible by client 102.

In one embodiment, a user of the browser 216 may access the server 106 through an authentication engine 218. The authentication engine 218 may include an application, a server, a process, a service, a daemon, or any other type and form of functionality for verifying and authenticating a user. In some embodiments, the authentication engine 218 may be embodied in hardware, software, or any combination thereof. In one embodiment, a user can be authenticated to the server by logging in and entering a username and password. In another embodiment, authentication may include a challenge and response protocol. In many embodiments, the authentication engine 218 may communicate or interact with a security database 220, which may be a data structure, file, registry, database, index, or any other type and form of data for storing user authentication data.

In some embodiments, the server 106 is configured with or executes a portal engine 222. The portal engine 222 may include an application, a server, a process, a service, a daemon, a server-side application, or any other combination of data and/or executable processes capable of providing an interface for a client via a browser 216. In some embodiments, the portal engine 222 may provide different interfaces for different users, for instance, based on a level of authentication. For example, the portal engine 222 may provide a first interface for an administrator, a second interface for an educator, a third interface for a student, and a fourth interface for a family member of a student. In one embodiment, the portal engine 222 may provide different interfaces based on different operational tasks. For example, the portal engine 222 may provide a first interface for an educator building a class or associating one or more students with one or more groups or classes. In another embodiment, the portal engine 222 may provide a second interface for the educator uploading devices, resources, and/or benchmarks to server 106 from a local storage device. In still another embodiment, the portal engine 222 may provide a third interface for the educator aligning resources with benchmarks. In yet another embodiment, the portal engine 222 may provide a fourth interface for assigning resources to students, classes, or groups of students.

In some embodiments, the portal engine 222 may interact with a message server 224. The message server 224 may include an application, a server, a process, a service, a daemon, or any type of executable instructions for creating, transmitting, storing, retrieving, and searching messages, such as a mail server. In one embodiment, the message server 224 may be used by an educator to transmit messages to his or her students and/or their family members. In another embodiment, the message server 224 may be used by a student to send a message to his or her teacher. In still another embodiment, the message server 224 may be used by the server to notify an educator or administrator of errors or completed tasks. In yet another embodiment, the message server 224 may be used to contact students responsive to their being associated with a class, group, benchmark, resource, or device. For example, in one such embodiment, a teacher may assign a resource to a class of students. Responsive to the assignment, the message server 224 may be directed by the portal engine 222 to transmit messages to each of the students, where the messages identify the assigned resource. In another such embodiment, a teacher may associate one or more students with a class. Responsive to the association, the message server 224 may be directed by the portal engine 222 to transmit messages to each student, indicating that they have been associated with a class. In a further embodiment, the message server 224 may transmit a message to each student, the message including an identifier or unique code. For example, in such an embodiment, a student may receive a message indicating that they have been assigned to a class, without their having previously accessed the portal engine. The message may include a unique login or identifier that the student may then use for access to the portal engine via authentication engine 218.

In some embodiments, the portal engine 222 can be an instructional portal such as iPASOS® created by the Trinity Education Group. In other embodiments, the portal engine 222 can be an instructional portal engine for English-speaking educators to assign non-English-language content to students. The educational content, devices or resources can be in any language. For example, the educational content can be in Spanish, French, German, Japanese, Chinese, Polish, Russian, Greek, Dutch, or any other language. In other embodiments, the educational content can pertain to any of the following contexts: Special Education; Speech Therapy; Counseling; Career and Vocational Education; and Higher Education. An educator can use the portal engine 222 to perform any of the following tasks: filed applicable educational resources (either as a supplement, intervention, or core instruction) through a variety of search mechanisms; view the selected education content and additional metadata associated with the educational content; build ad hoc groups or cohorts of students; and assign the educational content to a cohort or individuals within the cohort.

In one embodiment, the portal engine 222 may interact with an alignment engine 226 which can further be referred to as an educational alignment engine. The alignment engine 226 may include an application, a server, a process, a service, a daemon or any other type and form of executable instructions for managing, manipulating, editing, creating, and/or querying a relational database. In one embodiment, the alignment engine 226 may include a relational database management system such as Microsoft Access® or Microsoft SQL Server®, manufactured by Microsoft Corp.; MySQL®, manufactured by Sun Microsystems; Oracle®, manufactured by Oracle Corp.; or any other type and form of management system. In some embodiments, the alignment engine 226 may interact with one or more relational databases, including aligned resources 206 and assigned resources 214, and/or database elements including devices 200, resources 202, benchmarks 204, students 208, groups 210, and/or classes 212. In some embodiments, an educator or administrator may direct the alignment engine 226, via the portal engine 222, to create and/or modify associations in a relational database.

In one embodiment, the portal engine 222 may interact with a resource viewer 228. The resource viewer 228 may include an application, a server, a process, a service, a daemon or any other type and form of executable instructions for searching for, retrieving, displaying, modifying, and creating a resource or device. In some embodiments, the resource viewer 228 may execute on the server to serve resources and/or devices to browser 216. For example, the resource viewer 228 may generate one or more dynamic web pages for transmittal to and display on the browser 216, responsive to one or more commands from a user of the client 102. In one such embodiment, the resource viewer 228 may be operatively coupled to the message server 224, the alignment engine 226 and/or the class builder 230. For example, in one such embodiment, an educator may query a relational database to find educational devices associated with a curriculum benchmark, and view them with the resource viewer 228. Responsive to the query, the educator may assign the educational devices to a class of one or more students by modifying the association within the relational database. The message server 224 may then transmit one or more messages to the students responsive to the modified association, where the one or more messages notify the students about the assigned device.

In some embodiments, the resource viewer 228 may store a set of favorite resources, devices, and/or benchmarks 230 and/or a profile 232. In one embodiment, the list of favorites 230 may be specific to a profile 232, and the profile 232 may be specific to an authenticated user, student, class, parent or educator. For example, while searching for devices and resources to assign to students, an educator may store or bookmark the results of searches for later retrieval.

In one embodiment, the portal engine 222 may interact with a class builder 230. The class builder 230 may include an application, a server, a process, a service, a daemon or any other type and form of executable instructions for managing, manipulating, editing, creating, and/or querying a relational database. In one embodiment, the class builder 230 may include a relational database management system such as Microsoft Access® or Microsoft SQL Server®, manufactured by Microsoft Corp.; MySQL®, manufactured by Sun Microsystems; Oracle®, manufactured by Oracle Corp.; or any other type or form of management system. In some embodiments, the class builder 230 may interact with one or more relational databases or tables of a relational database, including aligned resources 206 and assigned resources 214, and/or database elements including devices 200, resources 202, benchmarks 204, students 208, groups 210, and/or classes 212. In some embodiments, an educator or administrator may direct the class builder 230, via the portal engine 222, to create and/or modify associations in a relational database. In one embodiment, the class builder 230 and the alignment engine 226 may be included in the same relational database management system.

In some embodiments, the server 106 may further include a memory element for storage of devices and/or benchmark files as described above. In one such embodiment, an educator or administrator may upload devices and files to the server 106 via the portal engine 222. In a further embodiment, the educator or administrator may create metadata associated with the uploaded devices and/or benchmark files. In some embodiments, this metadata may include tuples in a table of the relational database, as discussed above. In other embodiments, the metadata may be stored as part of a device, such as the ID3 header tags used in MP3 files, or may be stored in a separate file and associated with the device. For example, metadata may be stored in a “device_item_l .xml” file, such that resource builder 228 may identify the metadata as being associated with a device file. In a further embodiment, the relational database management system may parse the header of a device or an associated metadata file and create a tuple in a table associated with the device.

The resource builder 217, in some embodiments, communicates with any of the components executing on the server 106. The portal engine 222, in some embodiments, can control or otherwise manage the resource builder 217. In other embodiments, the resource builder 217 can be called an educational resource builder 217 or a resource creation engine. While FIG. 2C depicts the resource builder 217 as connected to the portal engine 222, in some embodiments the resource builder 217 can communicate with the alignment engine 226, the portal engine 222, the resource viewer 228 and any of the following data: aligned resources 206; educational devices 200; educational resources 202; educational or student benchmarks 204; assigned resources 214; or any other data stored on the server 106. In some embodiments, the resource builder 217 collects one or more educational devices 200 and/or educational resources 202 and builds an educational resource that includes the collected devices 200 and resources 202. A built educational resource 202, in some embodiments, can then be assigned to a benchmark 204, or can be aligned with one or more benchmarks 204 by the alignment engine 226 to create an aligned resource 206. In still other embodiments, the portal engine 222 or another program executing on the server 106 can assign a built or created educational resource 202 to a student 208, a group 210 or a class 212.

In some embodiments, any one of the following data can be stored in a storage repository (Not Shown) on the server 106: authentication information; authentication credentials associated with a parent, student, teacher or other user; favorites files 230; user profiles 232; educational class 212 identifiers; student identifiers 208; group or student cohort identifiers 210; educational or student benchmarks 204; educational resources 202; educational devices 200; aligned resources 206; and assigned resources 214. In other embodiments, any program or engine executing on the server 106 can access any data stored in the storage repository (Not Shown) on the server 106.

### C. Methods for Creating and Managing Educational Resources

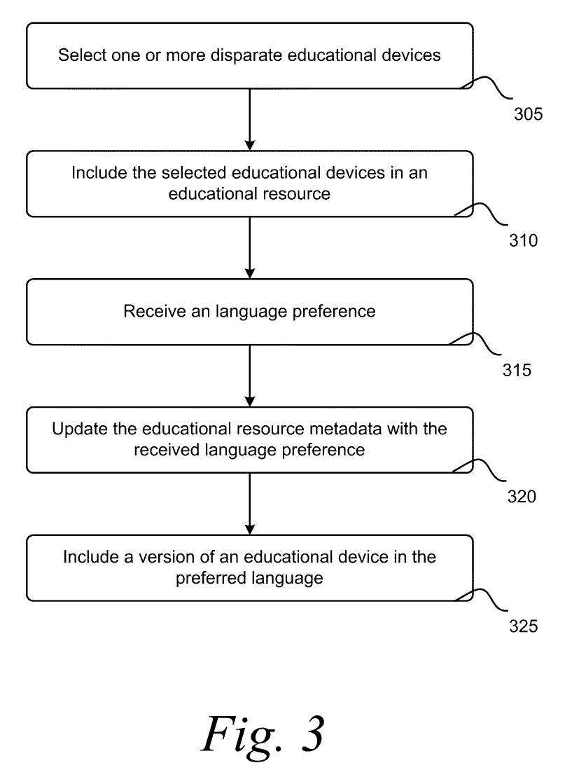

Illustrated in FIG. 3 is one embodiment of a method for creating an educational resource. In one embodiment, a resource builder 217 executing on the server 106 selects two or more disparate educational devices 200 (Step 305). The resource builder 217 then includes the selected educational devices in an educational resource (Step 310). In some embodiments, the resource builder 217 receives a language preference (Step 315), updates metadata of the educational resource with the received language preference (Step 320). The resource builder 217 can then include a version of an educational device in the preferred language (Step 325).

Further referring to FIG. 3, and in more detail, in one embodiment the described method is carried out by a resource builder 217 executing on the server 106. In other embodiments, the method can be carried out by the portal engine 222 executing on the server 106. In still other embodiments, the method can be carried out by any combination of the resource builder 217, the portal engine 222 or the alignment engine 226.

In some embodiments, the resource builder 217 can select two or more disparate educational devices (Step 305). An educational device 200 can be any file, object, presentation, or other teaching or learning resource, and can be in any of the above-described media formats. In some embodiments, the resource builder 217 can select devices from a storage repository (Not Shown) on the server 106. In other embodiments, the resource builder 217 can select devices from a storage repository on a remote server 106′, client 102 or other computing machine or appliance. In still other embodiments, the resource builder 217 can select devices from a remote storage repository accessible through the server 106. In one embodiment, the resource builder 217 can download devices from a network, or the resource builder can query remote databases for devices. A resource builder 217, in some embodiments, can select two devices, while in other embodiments the resource builder 217 can select more than two devices. In many embodiments, at least two of the selected devices are disparate such that they are two different media types. For example, a first educational device is a video file in a *.mp4 file format, and the second educational device is a document in a *.pdf format.

The resource builder 217, in some embodiments, can access those resources that have a specific audience and a specific language. For example, if a user specifies that Spanish is the default language and that the audience is children in grades Kindergarten through 8th grade, the user may only access educational devices or content having metadata describing it as a device in Spanish, and a device for students in grades Kindergarten through 8th grade. A user, in some embodiment, can search through available devices using any number of search terms. When the user wishes to select a device and add it, the user can click on a device or content and add it to the educational resource. In another embodiment, the user can highlight the device and direct the resource builder 217 to obtain the device and add it to the educational resource.

Upon selecting the at least two educational devices, the resource builder 217 can then include the selected educational devices in an educational resource (Step 310). Including an educational device in an educational resource can further require the resource builder 217 to create an educational resource. Creating an educational resource can, in some embodiments, include any of the following: setting up a table in a database; inserting an entry into a table in a database; creating a metadata object including resource information such as a title, creation date, and creator identifier; and or setting up a folder in a file directory.

In some embodiments, including the selected educational devices in an educational resource (Step 310) can include modifying an entry in a table of a database or a database to include file locators that point to the selected devices. For example, modifying the entry can include modifying the entry to include a file locator such as a file path, network path or other location identifier. In other embodiments, including the selected educational device in an educational resource can include inserting into a table, database or file an entry indicating the location of the devices. Still other embodiments include copying the identified devices in a folder or other storage repository location set aside for the educational resource.

The resource builder 217, in some embodiments, receives a language preference (Step 315). In some embodiments the resource builder 217 receives the language preference from the portal engine 222, the alignment engine 226, or any other engine or program executing on the server 106. The language preference, in some embodiments, can include data or information indicating a user's preferred language. For example, a language preference can include a first language, a second language, a third language, etc. Languages can include any dialect of any language, e.g. English, Spanish, French, Chinese, Japanese, German, Polish, etc. In some embodiments, the language preference can be entered by user through an educational resource configuration interface (Not Shown) displayed on a browser 216 of a client 102. The educational resource configuration interface, in some embodiments, can be a user interface managed by the portal engine 222 or the resource builder 217, and can be used by a user to configure an educational resource. Included within the educational resource configuration interface (Not Shown) can be a language preference object through which users can input their language preference. Upon an event on the interface, the server 106 can receive the user's language preference and identifiers identifying any one of the device, the resource, the client, a student, a teacher, a parent, a user, or a language. In some embodiments, the portal engine 222 receives the user's language preference and passed the preference to the resource builder 217.

In some embodiments, the resource builder 217 receives the language preference of a user and updates the educational resource metadata with the received language preference (Step 320). Updating the educational resource metadata can include entering a new entry into a table associated with the educational resource, updating a database entry for the educational resource, or configuring metadata associated with the educational resource. In some embodiments, updating the educational resource metadata can include configuring a metadata file stored in a storage repository on the server 106. The resource builder 217, in many embodiments, updates metadata or entries by indicating in the metadata or entry the language preference.

In some embodiments, a language preference can be user specific such that each resource and device associated with a particular user are in a specified language. In other embodiments, the language preference can be educational-resource specific such that each device or resource included in an educational resource are in a specified language. In still other embodiments, the language preference can be device specific such that each device can be configured to be in a specified language.

The resource builder 217, in some embodiments, includes a version of an educational device in the educational resource, where the included version is in a language specified in the language preference (Step 325). In some embodiments, the resource builder 217 can use a default language preference and include versions of selected educational devices that correspond to the default language preference. For example, the resource builder 217 can default to including all English versions of the educational devices. When a user specifies a language preference of Polish, the resource builder 217 can include educational resources, benchmarks, devices or other information in Polish. While in some embodiments, the resource builder 217 can replace an existing version of an educational device or resource with a version in the selected language; in other embodiments the resource builder 217 can include, together with the existing version, a second version of an educational device or resource in the selected language.

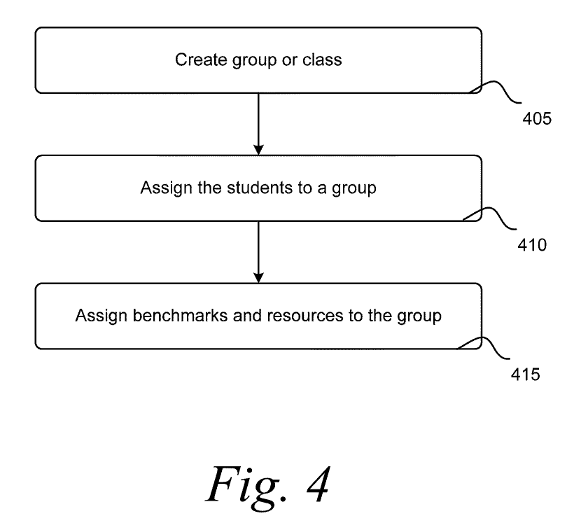

Illustrated in FIG. 4 is a method for grouping students together in a group, cohort or class. In some embodiments, a class builder 230 or the portal engine 222 selects one or more students (Step 405), assigns the selected students to a group (Step 410), and assigns benchmarks and resources to the group (Step 415).

Further referring to FIG. 4, and in more detail, in one embodiment a class builder 230 selects one or more students (Step 405). In other embodiments, the portal engine 222, a cohort builder (Not Shown) or any other application executing on the server 106 can select one or more students from a plurality of students. While FIG. 4 illustrates a method for building a group of students, in some embodiments the class builder 230 selects one or more students from a plurality of students, one or more parents from a plurality of parents and one or more teachers from a plurality of teachers. The class builder 230, in one embodiment, selects the students from a database, table or listing of available students. Student identifiers can be used to represent each available student. A student identifier can be any identifier, any identifier described herein, and any one of the following identifiers: name; social security number; student identification number; or student nickname. In some embodiments, the listing of students can be stored on a storage repository on the server 106.

In one embodiment, the class builder 230 assigns the students to a group (Step 410). The group can be a group of students, a cohort of students, a class of students or any other grouping of students. In some embodiments, assigning the students to a group can include modifying an entry associated with each student to indicate that student belongs to a particular group. In still other embodiments, assigning students to a group can include inserting into a table, listing or database associated with a particular group, an entry indicating that the selected students are part of that group. Assigning students to a group can, in some embodiments, include modifying metadata of the student identifiers, educational resource, educational resource identifiers or group identifiers to indicate that a student is part of a particular group.

A group can be any grouping of students, where the group can be defined by a user. These groups can also be called cohorts. A class can be any grouping of students in a particular educational class. For example, a class can be a grouping of students taking fifth grade math. In contrast, a group does not have to be defined by a class or outside activity. For example, a group or cohort can be a group of students assigned extra credit math assignments. A group or cohort could also be a group of students who are learning how to speak English.

The class builder 230, in some embodiments, can assign benchmarks and other resources to a group, cohort or class (Step 415). In one embodiment, the class builder 230 can assign a benchmark to a group of students, or benchmarks to each individual student in a group. For example, the class builder 230 can assign an advance placement chemistry benchmark to a group of students taking the advanced chemistry exam. In another embodiment, the class builder 230 can assign an educational resource created by the resource builder 217, to a group. For example, the class builder 230 can assign an educational resource including devices pertaining to World War II to a group of students doing a project on World War II. The class builder 230 can also assign any resources to a group of students, for example the following resources can be assigned: educational devices; educational resources; aligned resources; a favorites files; student profiles; teacher profiles; parent profiles; or any other information.

In another embodiment of step 410, the class builder 230 may allow one or more students to self-assign to a group, cohort, or class. For example, in one such embodiment, after an educator has created a class, group or cohort shell, identified by a description and/or metadata, the class builder 230 may create a unique identifier for the class, group or cohort. In one embodiment, the unique identifier may be an alphanumeric code. In a further embodiment, the class builder 230 may present or display the unique identifier to the educator via the portal, may send the unique identifier to the educator in an email or other message, and/or may send the unique identifier to one or more existing students, groups, classes, or cohorts. In another embodiment, a student may join a class, group, or cohort shell by entering the unique identifier into an input at the portal. This may reduce the need for an educator to manually assign students. For example, in one such embodiment, an educator may build a class shell for a Spanish class, and may create four group shells for projects within the class. The class builder may present a first unique identifier for the Spanish class, and four additional unique identifiers for the groups. The educator may notify students of the unique identifiers, via a handout, email, or even by writing the identifiers on a classroom blackboard. The students may then individually access the portal and enter one or more of the unique identifiers, such as an identifier for the class and an identifier for a group, into an input field for joining the group. Thus, upon entry, in some embodiments, the class builder may assign the student to the group and class.

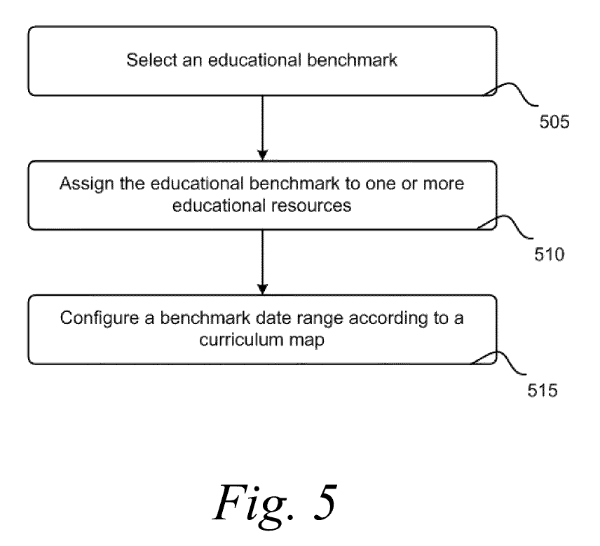

Illustrated in FIG. 5 is a method for aligning an educational resource with a benchmark. In some embodiments, an alignment engine 226 executing on the server 106, selects an educational benchmark (Step 505). The alignment engine 226 assigns the educational benchmark to one or more educational resources (Step 510), and configures the benchmark's date range according to a curriculum map.

Further referring to FIG. 5, and in more detail, in some embodiments the alignment engine 226 selects an educational benchmark (Step 505) from a plurality of benchmarks. Benchmarks, in some embodiments, can be any measurable student expectation. A benchmark can be a standard issued by any standards body such as: the federal government; a regional school district; a state education department; an archdiocese; an association of private schools; or any other standards issuing body. In some embodiments, the benchmark can be in a default language such as English. In other embodiments, the benchmark can be written in multiple different languages. Benchmarks, in some embodiments, can be stored in a storage repository on the server 106. In other embodiments, the alignment engine 226 can obtain educational resources from remote locations such as a remote computer or storage repository.

In some embodiments, the alignment engine 226 can select an educational benchmark in response to user input. For example, a user can request to align an educational resource with a benchmark. Upon making this request, the portal engine 222 can provide the user with a list of possible benchmarks, where possible benchmarks include any benchmark corresponding to the student, a class, an educational subject, a school district, a grade level, a type of student, or any educational attribute. In some embodiments, benchmarks are searchable through filters which can be used to filter a benchmark using a user's language preference, or to filter a benchmark using time and sequence. A user can search for and select educational benchmarks through a user interface managed by the portal engine 222 and displayed within a user's browser 216.

The alignment engine 226, in some embodiments, can assign the educational benchmark to one or more educational resources (Step 510). Assigning a benchmark to an educational resource can include: inserting an entry into a list, table or database indicating that the educational resource is associated with a particular benchmark; modifying metadata of the educational resource and/or the benchmark to indicate the relationship between the educational resource and benchmark; modifying an entry in one or more tables, lists or databases to indicate the relationship between the educational resource and the benchmark; and/or insert an entry in a table, list or database associated with the educational resource and/or the educational benchmark indicating that a relationship was formed between the educational resource and benchmark. In some embodiments, the alignment engine 226 can assign a benchmark to an educational resource once the alignment engine 226 verifies that the benchmark can be assigned to a particular educational resource. For example, the alignment engine 226 can review metadata for a benchmark for algebra to determine whether the benchmark should be assigned to a resource pertaining to introductory French. Upon reviewing the metadata for the algebra benchmark, the alignment engine 226 can return an error that indicates the benchmark is not compatible with the selected educational resource.

In some embodiments, the alignment engine 226 can configure a benchmark date range according to a curriculum map (Step 515). The alignment engine 226, in some embodiments, can be assigned a date range. For example, during the first two weeks of October, pre-algebra students are expended to cover single and multi-step equations according to a district's curriculum map. A benchmark date range, in some embodiments, can be modified using a user interface generated by the portal engine 222. The date range can correspond to a date range within the benchmark, or in some embodiments the benchmark can be configured so that the user generated date range can override a date range within the benchmark.

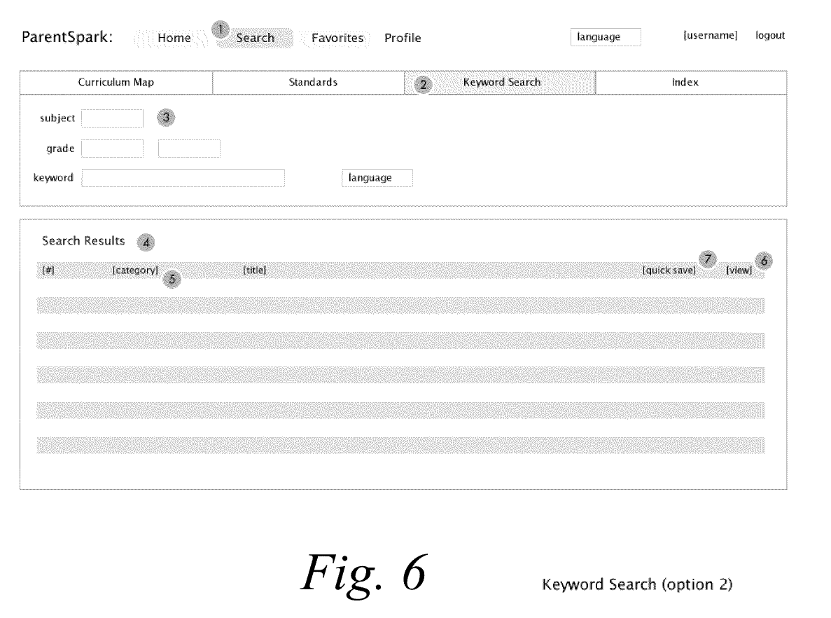

Illustrated in FIG. 6 is a user interface for parents. In some embodiments, the parent user interface can be a program executed by the portal engine 222 executing on the server 106. In other embodiments, the parent user interface can be generated by any program executing on the server 106. The user interface can include a search page where parents can search for resources using any number of search methods. Some of these search methods can include: a keyword search; a search for content by subject; a search for content by grade; a search for content by teacher; a search for content by group or cohort; a search for content by student; and a search for content by educational context (e.g. Speech Therapy, Special Education.)

Further referring to FIG. 6, and in more detail, in some embodiments the parent user interface can be ParentSpark® manufactured by the Trinity Education Group. In other embodiments, the parent user interface can be a learning portal for parents such that parents can access supplemental resources available to the parent. The supplemental resources available to each parent can be in any language. In some embodiments, the parents can filter content based on a language preference selected by the parent. In other embodiments, the parent can filter or search for content using any of the following criteria: number; grade; category; language and/or title. A parent, in some embodiments, can use the search feature of the parent user interface to search for content or resources aligned to what their child is learning, to save resources to folders and to print resources.

Although FIG. 6 illustrates a parent user interface with a search functionality, in some embodiments, the parent user interface can include a page for viewing additional student, teacher or school information. In some embodiments, additional pages within the parent user interface can display: school district messages; a preferred language selection section; and curriculum maps for a school district. Curriculum maps, in some embodiments, can be maps for a particular academic subject. For example, there can be a curriculum map for calculus and a different curriculum map for biology.

Parents can register with the parent user interface and can further be authenticated to the interface. Authentication, in some embodiments, can include obtaining from a user a username and a password. The portal engine 222 receives the username and password, applies a policy to the received credentials, and obtains any of the following information: a preferred language, a school district; a school; a student; or a teacher. Using this information, the user can be displayed information relevant to that parent's student.

When parents obtain resources using the parent user interface, in some embodiments, the parents can use the resource viewer 228 to view the resources. Thus, in some embodiments, the program generating the parent user interface can communicate with the resource viewer 228. When a user wishes to view a resource, the resource viewer 228 receives the resource information from the parent user interface and displays the resource within the resource viewer 228.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompany claims and their equivalents.

What is claimed is:

1. A method for creating an educational resource from one or more disparate educational devices, the method comprising:
including, by a resource builder executing on a computing machine, at least two disparate educational devices in an educational resource comprising metadata,
wherein the at least two disparate educational devices comprise a first educational device having a first media format and a second educational device having a second media format different from the first media format;
updating, by the resource builder, the educational resource metadata to include a language preference; and
including, by the resource builder, a version of an educational device corresponding to the language preference.

2. The method of claim 1, wherein updating the educational resource metadata to include a language preference further comprises:
selecting a first language from a plurality of languages; and
inserting the selected language into an educational resource configuration interface.

3. The method of claim 1, wherein including a version of the educational device corresponding to the language preference further comprises:
identifying a version of the educational device written in a language corresponding to the language preference; and
including the identified version of the educational device in the educational resource.

4. The method of claim 1, wherein including a first educational device having a first media format further comprises including a first educational device having a first media format comprising any one of the following media formats: audio, text, video, presentation, spreadsheet and multimedia.

5. The method of claim 1, wherein including a second educational device having a second media format further comprises including a second educational device having a second media format comprising any one of the following media formats: audio, text, video, presentation, spreadsheet and multimedia.

6. The method of claim 1, further comprising assigning the educational resource to a first student cohort.

7. The method of claim 6, further comprising:
selecting, by a class builder executing on the computing machine, one or more students from a group of available students; and
assigning, by the class builder, the selected one or more students to the first student cohort.

8. The method of claim 1, further comprising searching, by the resource builder, for educational devices in one or more educational device storage repositories on the computing machine.

9. The method of claim 1, further comprising aligning, by an alignment engine executing on the computing machine, the educational resource with a benchmark selected from a first plurality of benchmarks.

10. The method of claim 9, further comprising aligning, by the alignment engine, the educational resource with a second plurality of benchmarks selected from the first plurality of benchmarks, wherein the second plurality of benchmarks comprise alternate language versions of the same benchmark.

11. The method of claim 1, further comprising editing, by the resource builder, the educational resource metadata to include a media format description and an educational resource description.

12. A method for aligning an educational resource comprising one or more disparate educational devices, with at least one educational benchmark, the method comprising:
selecting, by an educational alignment engine executing on a computing machine, at least one educational benchmark corresponding to one of either a student, a student cohort and a class;
selecting, by the educational alignment engine, an educational resource comprising one or more disparate educational devices,
wherein the at least two disparate educational devices comprise a first educational device having a first media format and a second educational device having a second media format different from the first media format;
assigning, by the educational alignment engine, the selected educational resource to the selected educational benchmark; and
configuring, by the educational alignment engine, a date range of the selected educational benchmark according to a curriculum map.

13. The method of claim 12, further comprising searching, by the educational alignment engine within a database storing a plurality of educational benchmarks, for an educational benchmark corresponding to one of either a student, a student cohort and a class.

14. The method of claim 13, wherein searching further comprises selecting a language preference, and searching for the educational benchmark in the selected language preference.

15. The method of claim 12, wherein selecting at least one educational benchmark further comprises selecting at least one educational benchmark comprising one of a district educational standard, a state educational standard, and a national educational standard.

16. The method of claim 12, wherein including a first educational device having a first media format further comprises including a first educational device having a first media format comprising any one of the following media formats: audio, text, video, presentation, spreadsheet and multimedia.

17. The method of claim 12, wherein including a second educational device having a second media format further comprises including a second educational device having a second media format comprising any one of the following media formats: audio, text, video, presentation, spreadsheet and multimedia.

18. A system for creating and managing an educational resource comprising one or more disparate educational devices, the system comprising:
a computing machine;
a resource builder executing on the computing machine to:
include in an educational resource at least two disparate educational devices,
wherein the at least two disparate educational devices comprise a first educational device having a first media format and a second educational device having a second media format different from the first media format,
update metadata of the educational resource to include a language preference, and
include a version of an educational device corresponding to the language preference; and
an educational alignment engine executing on the computing machine to:
select at least one educational benchmark corresponding to one of either a student, a student cohort and a class,
assign the educational resource to the selected educational benchmark, and
configure a date range of the selected educational benchmark according to a curriculum map.

19. The system of claim 18, wherein the resource builder assigns the educational resource to a first student cohort.

20. The system of claim 19, further comprising a class builder executing on the computing machine to select one or more students from a group of available students, and assign the selected one or more students to the first student cohort.

21. The system of claim 18, wherein the resource builder identifies a version of the educational device corresponding to the language preference, and includes the identified version of the educational device in the educational resource.
